(19) United States
(12) Patent Application Publication
(10) Pub. No.: US 2021/0018332 A1
(43) Pub. Date: Jan. 21, 2021

(54) POI NAME MATCHING METHOD, APPARATUS, DEVICE AND STORAGE MEDIUM

(71) Applicant: BEIJING BAIDU NETCOM SCIENCE TECHNOLOGY CO., LTD., Beijing (CN)

(72) Inventors: Chongli ZHU, Beijing (CN); Hongwei XIE, Beijing (CN); Kuan SONG, Beijing (CN)

(21) Appl. No.: 16/931,529

(22) Filed: Jul. 17, 2020

(30) Foreign Application Priority Data
Jul. 17, 2019 (CN) 201910644777.4

(51) Int. Cl. G01C 21/00; G06N 3/08; G01C 21/36; G06K 9/62

(52) U.S. Cl. CPC G01C 21/3811; G06K 9/6256; G01C 21/3679; G06N 3/08

(57) ABSTRACT

Embodiments of the present disclosure provide a POI name matching method, apparatus, device and storage medium, which obtain a first POI name and a second POI name that are to be matched; obtain a similarity between the first POI name and the second POI name according to a pre-trained network model; and determine that a first POI and a second POI are the same POI entity in name semantics when the similarity is higher than a preset threshold. The embodiments determine a semantic similarity between POI names through the pre-trained network model, which realizes the POI name matching without needing to maintain a large number of manual rules and depending on similarity feature of manually extracted POI names, and has higher accuracy, better maintainability and higher processing efficiency.

### CROSS-REFERENCE TO RELATED APPLICATION

This application claims priority to Chinese Patent Application No. 201910644777.4, filed on Jul. 17, 2019, which is hereby incorporated by reference in its entirety.

### TECHNICAL FIELD

The present disclosure relates to the technical field of communications, and, in particular, to a POI name matching method, apparatus, device and storage medium.

### BACKGROUND

Point of interest (POI) is a term in a geographic information system, which refers to all geographic objects that can be abstracted as points, especially some geographic entities closely related to people's lives, such as schools, banks, restaurants, gas stations, hospitals, supermarkets. POI can be recorded in an electronic map to meet query needs in people's daily for information such as the POI location.

When it needs to add POIs, de-duplicate POIs, supplement a basic attribute of POIs or supplement a content attribute of POIs in a map, it is usually necessary to carry out duplicate determination, that is, to determine whether two POIs are the same spatial entity, which will generally involve determinations of POI name similarity and spatial similarity. For the determination of POI name similarity, a rule-based method can be adopted to compare whether names of two POIs are similar and the two POI names are the same spatial entity through rules. Alternatively, a traditional machine learning model such as Gradient Boosted Descent Tree (GBDT) or Maximum Entropy Model (ME) is adopted, that is, the result calculated through the rules is converted into a discrete value feature or a continuous value feature, and then dichotomy is determined by the traditional machine learning model.

In the prior art, the rule-based method needs to maintain a large number of obsolete manual rules, is difficult to add new manual rules into the obsolete rules, is difficult to continue iteration, and has low accuracy rate; however, compared with the rule-based method, the traditional machine learning model has stronger generalization ability, but it still needs to depend on the rule to calculate the result and a similarity feature of manually extracted POIs, and also has low accuracy.

### SUMMARY

Embodiments of the present disclosure provide a POI name matching method, apparatus, device and storage medium to improve maintainability and accuracy without needing to maintain a large number of manual rules and depending on similarity feature of manually extracted POI names

A first aspect of the embodiments of the present disclosure provides a POI name matching method, including:

obtaining a first POI name of a first POI and a second POI name of a second POI that are to be matched;

obtaining a similarity between the first POI name and the second POI name according to a pre-trained network model; and

determining that the first POI and the second POI are the same POI entity in name semantics when the similarity is higher than a preset threshold.

A second aspect of the embodiments of the present disclosure provides a POI name matching apparatus, including:

an obtaining module, configured to obtain a first POI name of a first POI and a second POI name of a second POI that are to be matched; and

a processing module, configured to obtain a similarity between the first POI name and the second POI name according to a pre-trained network model; and determine that the first POI and the second POI are the same POI entity in name semantics when the similarity is higher than a preset threshold.

A third aspect of the embodiments of the present disclosure provides a POI name matching device, including:

a memory;

a processor; and

a computer program;

where the computer program is stored in the memory and configured to be executed by the processor to implement the method as described in the first aspect.

A fourth aspect of the embodiments of the present disclosure provides a computer readable storage medium having a computer program stored thereon;

the computer program, when executed by a processor, implements the method as described in the first aspect.

The POI name matching method, apparatus, device and storage medium for provided by the embodiments of the present disclosure obtain a first POI name of a first POI and a second POI name of a second POI that are to be matched; obtain a similarity between the first POI name and the second POI name according to a pre-trained network model; and determine that the first POI and the second POI are the same POI entity in name semantics when the similarity is higher than a preset threshold. The embodiments determine a semantic similarity between POI names through the pre-trained network model, which realizes the POI name matching without needing to maintain a large number of manual rules and depending on similarity feature of manually extracted POI names, and has higher accuracy, better maintainability and higher processing efficiency.

### BRIEF DESCRIPTION OF THE DRAWINGS

The following is a brief description of drawings needed in description of the embodiments and the prior art, so as to more clearly explain technical solutions in the embodiments of the present disclosure or the prior art. It is obvious that the drawings in the following description are only some embodiments of the present disclosure. For those of ordinary skill in the art, other drawings can be obtained according to these drawings without creative labor.

FIG. 1 is a flowchart of a POI name matching method according to an embodiment of the present disclosure;

FIG. 2 is a flowchart of a POI name matching method according to another embodiment of the present disclosure;

FIG. 3 is a structural diagram of a pre-trained network model according to an embodiment of the present disclosure;

FIG. 4 is a structural diagram of a pre-trained network model according to another embodiment of the present disclosure;

FIG. 5 is a structural diagram of a POI name matching apparatus according to an embodiment of the present disclosure; and

FIG. 6 is a structural diagram of a POI name matching device according to an embodiment of the present disclosure.

### DESCRIPTION OF EMBODIMENTS

The technical solutions in the embodiments of the present disclosure will be described clearly and completely below with reference to the accompanying drawings in the embodiments of the present disclosure. Obviously, the described embodiments are only some embodiments of the present disclosure, not all of them. Based on the embodiments of the present disclosure, all other embodiments obtained by those of ordinary skill in the art without creative labor shall fall within the protection scope of the present disclosure.

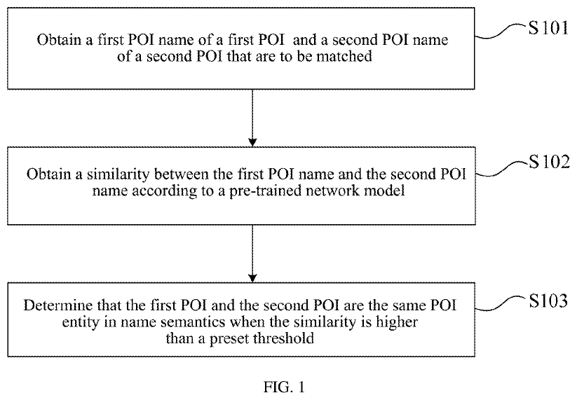

FIG. 1 is a flowchart of a POI name matching method according to an embodiment of the present disclosure. The embodiment provides a POI name matching method, specific steps of which are as below:

S101, obtain a first POI name of a first POI and a second POI name of a second POI that are to be matched.

The embodiment can be applied to duplicate determination of an added POI, that is, the added POI is compared with existing POIs in a map. The added POI is added into the map when it is different from the existing POIs. Comparison process of the added POI with the existing POIs in the map involves comparison of a semantic similarity of POI names, comparison of location information, comparison of contact information, comparison of POI categories, etc. The embodiment of the present disclosure only relates to the comparison of semantic similarity of POI names. In addition, the embodiment can also be applied to POI query, for example, a user's query instruction includes the first POI name. When it is desired to query a target POI from the map according to the first POI name, the comparison of semantic similarity can be carried out between the first POI name and POI names in the map to query the target POI with higher semantic similarity of names Of course, the embodiment can also be applied to other scenarios, where comparison of semantic similarity is not limited to POI names in geographic information system, but also can be used between two character strings in other fields.

Based on the above application scenario, in the embodiment, the first POI name and the second POI name that are to be matched can be first obtained, and then they are input into a pre-trained network model for performing the following steps.

S102, obtain a similarity between the first POI name and the second POI name according to the pre-trained network model.

In the embodiment, the pre-trained network model is configured to obtain a semantic similarity between two character strings. The pre-trained network model can be specifically a neural network model or other machine learning models. By inputting the obtained first POI name and the second POI name into the pre-trained network model, the similarity between the first POI name and the second POI name can be output.

S103, determine that the first POI and the second POI are the same POI entity in name semantics when the similarity is higher than a preset threshold.

In the embodiment, the similarity between the first POI name and the second POI name is compared with the preset threshold. When the similarity between the first POI name and the second POI name is higher than the preset threshold, it can be determined that the similarity between the first POI name and the second POI name is high, that is, the first POI and the second POI are the same POI entity (same spatial entity) in name semantics. Of course, it may not be 100% certain that the two POIs are the same POI entity after determining that they are the same POI entity in name semantics, and further comparison such as comparison of location information, comparison of contact information, comparison of POI categories, can be carried out to confirm that the two POIs are the same POI entity (in which different comparison results can be set to have different weights). Other comparison processes can be specifically implemented through decision trees or other methods, which will not be repeated herein.

The POI name matching method according to the embodiment obtains a first POI name of a first POI and a second POI name of a second POI that are to be matched; obtains a similarity between the first POI name and the second POI name according to a pre-trained network model; and determines that the first POI and the second POI are the same POI entity in name semantics when the similarity is higher than a preset threshold. The embodiment determines a semantic similarity between POI names through the pre-trained network model, which realizes the POI name matching without needing to maintain a large number of manual rules and depending on similarity feature of manually extracted POI names, and has higher accuracy, better maintainability and higher processing efficiency.

On the basis of the above embodiment, the pre-trained network model includes a self attention unit and a multi-head attention unit; and

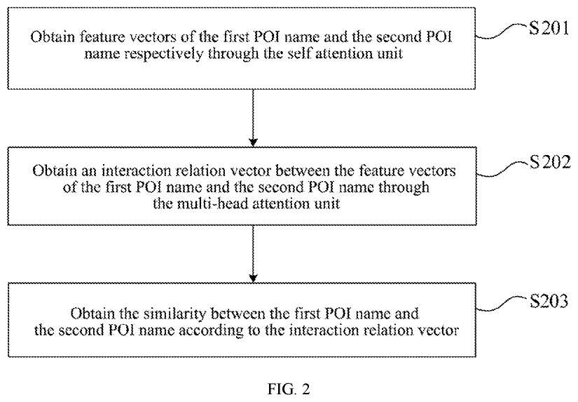

as shown in FIG. 2, the obtaining a similarity between the first POI name and the second POI name according to the pre-trained network model, includes:

S201, obtain feature vectors of the first POI name and the second POI name respectively through the self attention unit;

S202, obtaining an interaction relation vector between the feature vectors of the first POI name and the second POI name through the multi-head attention unit; and

S203, obtaining the similarity between the first POI name and the second POI name according to the interaction relation vector.

In the embodiment, the feature vectors of the POI names can be obtained by referring to Google's Transformer translation model and using a self attention mechanism. Specifically, a dependency between each word or character and other words or characters in the POI names can be obtained through the self attention mechanism, and finally the feature vectors of the POI names are obtained to represent context information of each word or character in the POI names. The number of the self attention unit is not limited to one, and a plurality of self attention units can be connected in sequence to gradually obtain the feature vectors of the POI names from a shallow level to a deep level; after the feature vector of each POI name is obtained, an interaction relation between the two POI names during comparison is calculated through a multi-head attention mechanism to obtain the interaction relation vector between the feature vectors of the two POI names; further, after the interaction relation vector between the feature vectors of the two POI names is obtained, the similarity between the two POI names can be obtained according to the interaction relation vector, and then whether the two POIs are the same POI entity in name semantics can be determined according to the similarity.

Further, the obtaining the similarity between the first POI name and the second POI name according to the interaction relation vector includes:

perform dichotomy according to the interaction relation vector to obtain the similarity between the first POI name and the second POI name.

In the embodiment, Softmax regression can be used for performing dichotomy on the interaction relation vector to determine whether the two POI names are similar or not, and to give a corresponding probability, thereby obtaining the similarity between the two POI names. Of course, other classifiers can also be used in the embodiment, which will not be repeated herein.

In addition, in the above embodiment, after the first POI name and the second POI name are input into the pre-trained network model, the input POI name can be first encoded by an embedding layer to obtain a POI name expressed in vector form, and then the POI name expressed in vector form is input into the self attention unit to enable the self attention unit to obtain the feature vector of the POI name according to the POI name expressed in vector form.

The POI name matching method according to the embodiment obtains a first POI name of a first POI and a second POI name of a second POI that are to be matched; obtains a similarity between the first POI name and the second POI name according to a pre-trained network model; and determines that the first POI and the second POI are the same POI entity in name semantics when the similarity is higher than a preset threshold. The embodiment determines a semantic similarity between POI names through the pre-trained network model, which realizes the POI name matching without needing to maintain a large number of manual rules and depending on similarity feature of manually extracted POI names, and has higher accuracy, better maintainability and higher processing efficiency. In addition, an attention mechanism is adopted in the embodiment, resulting in a deeper network level, and judging from the model effect, the added and associated recall rates can be greatly improved on the premise of ensuring accuracy.

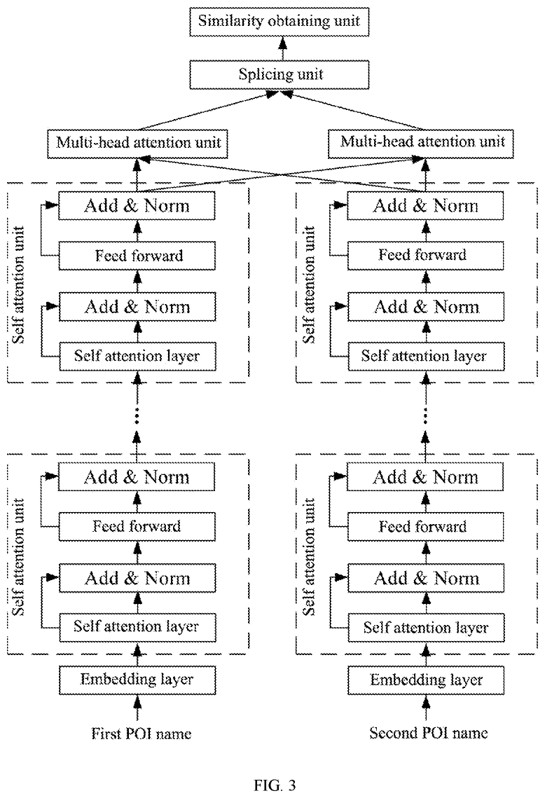

On the basis of any one of the above embodiments, in an option embodiment, as shown in FIG. 3, the pre-trained network model includes two sub-networks which are symmetrical to each other, and each sub-network includes the self attention unit and the multi-head attention unit; where the first POI name and the second POI name are respectively input into the two sub-networks; the multi-head attention unit of each sub-network is configured to obtain the interaction relation vector of the feature vector of the POI name in the other sub-network with respect to the feature vector of the POI name in that sub-network.

More specifically, as shown in FIG. 3, each sub-network further includes an embedding layer. The first POI name and the second POI name can be respectively input into the embedding layer of the two sub-networks, the input POI name is encoded by the embedding layer to obtain a POI name expressed in vector form, so that the feature vector of the POI name is obtained by the self attention unit according to the POI name expressed in the vector form.

In the two sub-networks in the embodiment, a plurality of self attention units are sequentially connected to gradually obtain the feature vectors of the POI names from a shallow level to a deep level, where each self attention unit includes a self attention layer and a feed forward, and the feed forward is used to perform permutation and combination on features extracted from the self attention layers to form the feature vectors of the POI names.

Further, the self attention unit inputs the finally obtained feature vectors of the POI names into the multi-head attention units. Because each sub-network has the multi-head attention unit, and the multi-head attention units of the two sub-networks are connected with each other, that is, each multi-head attention unit can obtain the feature vectors of the two POI names. The two multi-head attention units respectively calculate the interaction relation vector between the feature vectors of the first and the second POI names, where one multi-head attention unit calculates an interaction relation vector of the feature vector of the second POI name with respect to the feature vector of the first POI name, and the other multi-head attention unit calculates an interaction relation vector of the feature vector of the first POI name with respect to the feature vector of the second POI name.

After the two interaction relation vectors are obtained, the two interaction relation vectors are spliced to obtain a spliced interaction relation vector, and a splicing unit (for example, realized by Concat) can be provided in the pre-trained network model; and then the similarity between the first POI name and the second POI name is obtained from the spliced interaction relation vector. Specifically, a similarity obtaining unit is provided in the pre-trained network model, for example, a dichotomy is performed on the interaction relation vector through Softmax regression to determine whether the two POI names are similar or not, and to give a corresponding probability, so that the similarity between the two POI names can be obtained. In the embodiment, the two multi-head attention units are used to obtain forward and backward interaction relation vectors and subsequently splice the interaction relation vectors, which can improve the accuracy of obtaining similarity and avoid the problem of forward and backward inconsistency in the similarity determination process, that is, a result of determining whether the first POI name is similar to the second POI name may be different from a result of determining whether the second POI name is similar to the first POI name.

Further, the layers in the embodiment can be connected in the way of Add & Norm, which can be responsible for residual connection and feature vector normalization in the training process.

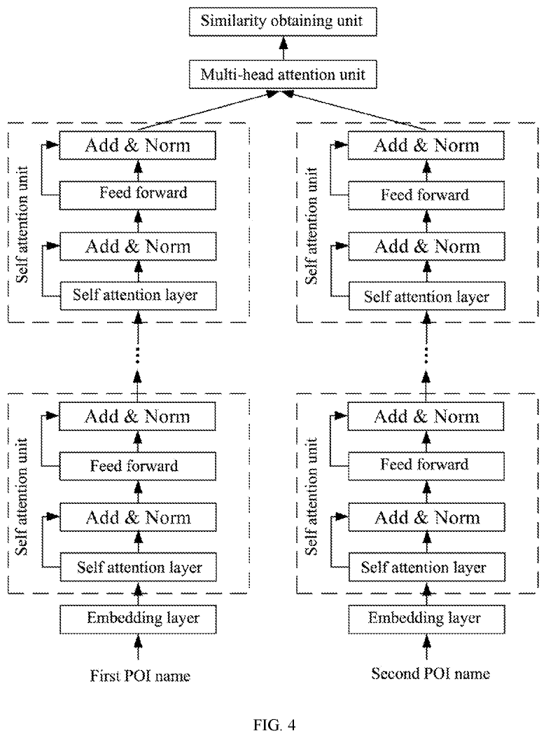

In another alternative embodiment, as shown in FIG. 4, the pre-trained network model includes two sub-networks which are symmetrical to each other, each sub-network includes the self attention unit, the two sub-networks are connected with the multi-head attention unit, and the feature vector of the POI name obtained by the self attention unit of each sub-network is input into the multi-head attention unit to obtain the interaction relation vector between the feature vectors of the first POI name and the second POI name through the multi-head attention unit.

In the embodiment, the problem of forward and backward inconsistency in the similarity determination process is not considered, that is, each sub-network includes the self attention unit and does not include the multi-head attention unit, the feature vector of the POI name obtained by the self attention unit of each sub-network is input into the multi-head attention unit, and the multi-head attention unit obtains only one interaction relation vector between the feature vectors of the first POI name and the second POI name. Furthermore, the splicing unit is not required for the pre-trained network model of the embodiment, and the interaction relation vector is directly input into the similarity obtaining unit to obtain the similarity of the two POI names.

Other layers of the pre-trained network model in the embodiment can be referred to the pre-trained network model of the above embodiment and will not be repeated herein.

On the basis of any one of the above embodiments, the POI name matching method further includes a model training process, which specifically includes:

obtaining training data, and training the pre-trained network model according to the training data.

In the embodiment, in the model training process, cross entropy can be adopted as a model loss function, Momentum can be adopted as an optimization method, and the cross entropy is minimized by gradient descent method to obtain a model parameter. Of course, the training method is not limited to the above and will not be repeated herein.

The obtaining of training data, includes:

obtaining positive example data in the training data according to POI entities with different names in a database; and/or

constructing negative example data in the training data according to a user's POI query instruction and a corresponding query result; and/or

obtaining POIs with parent-child relationship or sibling relationship in the database to obtain the negative example data; and/or

obtaining POIs in which a similarity of character strings in POI names is lower than a threshold value in the database to obtain the negative example data; and/or

selecting POIs with different core words or suffixes contained in POI names in the database to obtain the negative example data.

In the embodiment, for the positive example data in the training data, the same POI entity with different names can be queried from the data. For example, “Peking University” and “Beijing University” are the same POI entity with different names Then, the two names of the POI entity can be taken as one positive example data. At least one of the above-mentioned multiple obtaining methods can be adopted to obtain the negative example data in the training data. The negative example data in the training data is constructed according to the user's POI query instruction and the corresponding query result. For example, when the user queries “Peking University”, results that are unrelated to Peking University and are not the same POI entity, such as “Peking University of Posts and Telecommunications”, “Peking Jiaotong University” and so on, may be returned, so that the negative example data can be constructed according to the user's POI query instructions and the corresponding query result. The negative example data can also be constructed according to a relationship between POIs, such as parent-child relationship (for example, a name of a business circle and a name of a store in the business circle), sibling relationship (names of different stores in the same business circle). The negative example data can also be obtained according to POIs with different core words or suffixes contained in POI names, such as different stores belonging to the same company, or stores of the same type belonging to different companies. In addition, completely irrelevant POI names can be obtained as long as a similarity of character strings in the two POI names is lower than a threshold value, where the similarity of character strings can be calculated by Longest Common Subsequence (LCS). In the embodiment, a ratio of the positive example data to the negative example data in the training data can be controlled, for example, as 1:3, and a purity of the training data reaches 95%. Through massive training samples, the pre-trained network model can be better trained and the accuracy of the model can be improved.

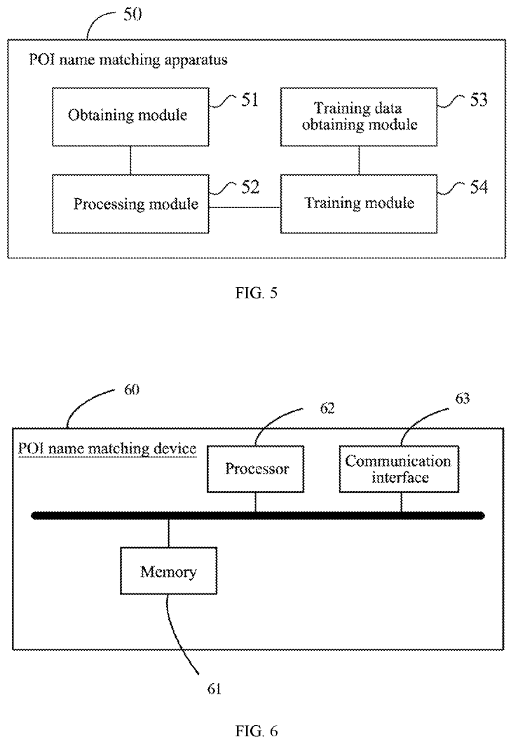

FIG. 5 is a structural diagram of a POI name matching device according to an embodiment of the present disclosure. The POI name matching device provided in the embodiment can execute the processing flow provided in the embodiment of the POI name matching method. As shown in FIG. 5, the POI name matching device 50 includes an obtaining module 51 and a processing module 52.

The obtaining module 51 is configured to obtain a first POI name of a first POI and a second POI name of second first POI that are to be matched; and

the processing module 52 is configured to obtain a similarity between the first POI name and the second POI name according to a pre-trained network model; and determine that the first POI and the second POI are the same POI entity in name semantics when the similarity is higher than a preset threshold.

On the basis of any one of the above embodiments, the pre-trained network model includes a self attention unit and a multi-head attention unit;

the processing module 52 is configured to:

obtain feature vectors of the first POI name and the second POI name respectively through the self attention unit;

obtain an interaction relation vector between the feature vectors of the first POI name and the second POI name through the multi-head attention unit; and

obtain the similarity between the first POI name and the second POI name according to the interaction relation vector.

On the basis of any one of the above embodiments, the pre-trained network model includes two sub-networks which are symmetrical to each other, and each sub-network includes the self attention unit and the multi-head attention unit;

where the first POI name and the second POI name are respectively input into the two sub-networks; the multi-head attention unit of each sub-network is configured to obtain the interaction relation vector of the feature vector of the POI name in the other sub-network with respect to the feature vector of the POI name in that sub-network;

the pre-trained network model further includes a splicing unit and a similarity obtaining unit;

the processing module 52 is configured to:

splice the interaction relation vectors obtained by the two sub-networks through the splicing unit to obtain a spliced interaction relation vector; and

obtain the similarity between the first POI name and the second POI name according to the spliced interaction relation vector through the similarity obtaining unit.

On the basis of any one of the above embodiments, the pre-trained network model includes two sub-networks which are symmetrical to each other, each sub-network includes the self attention unit, the two sub-networks are connected with the multi-head attention unit, and the feature vector of the POI name obtained by the self attention unit of each sub-network is input into the multi-head attention unit to obtain the interaction relation vector between the feature vectors of the first POI name and the second POI name through the multi-head attention unit; the pre-trained network model further includes a similarity obtaining unit, the processing module is configured to obtain the similarity between the first POI name and the second POI name according to the interaction relation vector through the similarity obtaining unit.

On the basis of any one of the above embodiments, the processing module 52 is configured to:

perform dichotomy according to the interaction relation vector to obtain the similarity between the first POI name and the second POI name.

On the basis of any one of the above embodiments, the two sub-networks further include an embedding layer; and

the processing module 52 is configured to:

encode the input POI name through the embedding layer to obtain a POI name expressed in vector form, so as to enable the self attention unit to obtain the feature vector of the POI name according to the POI name expressed in vector form.

On the basis of any one of the above embodiments, the device 50 further includes:

a training data obtaining module 53, configured to obtain training data; and

a training module 54, configured to train the pre-trained network model according to the training data;

where the training data obtaining module 53 is specifically configured to:

obtain positive example data in the training data according to POI entities with different names in a database; and/or

construct negative example data in the training data according to a user's POI query instruction and a corresponding query result; and/or

obtain POIs with parent-child relationship or sibling relationship in the database to obtain the negative example data; and/or

obtain POIs in which a similarity of character strings in POI names is lower than a threshold value in the database to obtain the negative example data; and/or

select POIs with different core words or suffixes contained in POI names in the database to obtain the negative example data.

The POI name matching device according to the embodiment of the present disclosure can be specifically used to execute the method embodiment provided in above FIGS. 1-2, and specific functions thereof will not be repeated herein.

The POI name matching device according to the embodiment of the present disclosure obtains a first POI name and a second POI name that are to be matched; obtains a similarity between the first POI name and the second POI name according to a pre-trained network model; and determines that a first POI and a second POI are the same POI entity in name semantics when the similarity is higher than a preset threshold. The embodiment determines a semantic similarity between POI names through the pre-trained network model, which realizes the POI name matching without needing to maintain a large number of manual rules and depending on similarity feature of manually extracted POI names, and has higher accuracy, better maintainability and higher processing efficiency.

FIG. 6 is a schematic structural diagram of a POI name matching device according to an embodiment of the present disclosure. The POI name matching device according to the embodiment of the present disclosure can execute the processing flow provided in the embodiment of the POI name matching method. As shown in FIG. 6, the POI name matching device 60 includes a memory 61, a processor 62, a computer program and a communication interface 63, where the computer program is stored in the memory 61 and configured to execute by the processor 62 to implement the POI name matching method described in the above embodiment.

The POI name matching device of the embodiment shown in FIG. 6 can be used to implement the technical solution of the above method embodiment, and the implementation principle and technical effect thereof are similar, which will not be repeated herein.

In addition, the embodiment further provides a computer readable storage medium having a computer program stored thereon; the computer program, when executed by a processor, implements the POI name matching method described in the above embodiments.

In several embodiments provided by the present disclosure, it should be understood that the disclosed apparatuses and methods can be implemented in other ways. For example, the apparatus embodiments described above are only schematic. For example, the division of the units is only a logic function division, and there may be other division methods in actual implementation. For example, multiple units or components may be combined or integrated into another system, or some features may be ignored or not implemented. On the other hand, the mutual coupling or direct coupling or communication connection shown or discussed may be indirect coupling or communication connection through some interfaces, apparatuses or units, and may be in electrical, mechanical or other forms.

The units described as separate units may or may not be physically separated, and the components displayed as units may or may not be physical units, that is, they may be located in one place or may be distributed over multiple network units. Some or all of the units can be selected as required to achieve the purpose of the embodiment.

In addition, each functional unit in each embodiment of the present disclosure may be integrated into one processing unit, each unit may exist physically separately, or two or more units may be integrated into one unit. The above-mentioned integrated units can be implemented in the form of either hardware or hardware plus software functional units.

The above integrated units implemented in the form of software functional units may be stored in a computer readable storage medium. The above-mentioned software functional unit is stored in a storage medium and includes several instructions for causing a computer device (which may be a personal computer, a server, or a network device, etc.) or a processor to perform some steps of the method described in various embodiments of the present disclosure. The aforementioned storage medium includes: U disk, removable hard disk, Read-Only Memory (ROM), Random Access Memory (RAM), magnetic disk or optical disk and other media that can store program codes.

Those skilled in the art can clearly understand that for convenience and conciseness of description, only the division of the above-mentioned functional modules will be illustrated. In actual application, the above-mentioned function can be distributed for being completed by different functional modules as required, that is, the internal structure of the apparatus is divided into different functional modules to complete all or part of the above-mentioned functions. The specific working process of the apparatus described above may refer to the corresponding process in the previous method embodiment and will not be repeated herein.

Finally, it should be noted that the above embodiments are merely illustrative of the technical solutions of the present disclosure, and are not to be taken in a limiting sense; although the present disclosure has been described in detail with reference to the above embodiments, those skilled in the art will understand that they may still modify the technical solutions described in the above embodiments, or equivalently substitute some or all of the technical features; and the modifications or substitutions do not deviate the nature of the corresponding technical solutions from the scope of the technical solutions of the embodiments of the present disclosure.

What is claimed is:

1. A point of interest (POI) name matching method, comprising:
obtaining a first POI name of a first POI and a second POI name of a second POI that are to be matched;
obtaining a similarity between the first POI name and the second POI name according to a pre-trained network model; and
determining that the first POI and the second POI are the same POI entity in name semantics when the similarity is higher than a preset threshold.

2. The method of claim 1, wherein the pre-trained network model comprises a self attention unit and a multi-head attention unit; and
the obtaining a similarity between the first POI name and the second POI name according to a pre-trained network model, comprises:
obtaining feature vectors of the first POI name and the second POI name respectively through the self attention unit;
obtaining an interaction relation vector between the feature vectors of the first POI name and the second POI name through the multi-head attention unit; and
obtaining the similarity between the first POI name and the second POI name according to the interaction relation vector.

3. The method of claim 2, wherein the pre-trained network model comprises two sub-networks which are symmetrical to each other, and each sub-network comprises the self attention unit and the multi-head attention unit;
wherein the first POI name and the second POI name are respectively input into the two sub-networks; the multi-head attention unit of each sub-network is configured to obtain the interaction relation vector of the feature vector of the POI name in the other sub-network with respect to the feature vector of the POI name in that sub-network.

4. The method of claim 3, wherein the obtaining the similarity between the first POI name and the second POI name according to the interaction relation vector, comprises:
splicing the interaction relation vectors obtained by the two sub-networks to obtain a spliced interaction relation vector; and
obtaining the similarity between the first POI name and the second POI name according to the spliced interaction relation vector.

5. The method of claim 2, wherein the pre-trained network model comprises two sub-networks which are symmetrical to each other, each sub-network comprises the self attention unit, the two sub-networks are connected with the multi-head attention unit, and the feature vector of the POI name obtained by the self attention unit of each sub-network is input into the multi-head attention unit to obtain the interaction relation vector between the feature vectors of the first POI name and the second POI name through the multi-head attention unit.

6. The method of claim 2, wherein the obtaining the similarity between the first POI name and the second POI name according to the interaction relation vector, comprises:
performing dichotomy according to the interaction relation vector to obtain the similarity between the first POI name and the second POI name.

7. The method of claim 3, wherein the two sub-networks further comprise an embedding layer.

8. The method of claim 7, wherein the inputting the first POI name and the second POI name respectively into the two sub-networks, comprises:
encoding the input POI name through the embedding layer to obtain a POI name expressed in vector form, so as to enable the self attention unit to obtain the feature vector of the POI name according to the POI name expressed in vector form.

9. The method of claim 1, comprising:
obtaining training data, and training the pre-trained network model according to the training data;
wherein the obtaining training data, comprises performing at least one of the following:
obtaining positive example data in the training data according to POI entities with different names in a database;
constructing negative example data in the training data according to a user's POI query instruction and a corresponding query result;
obtaining POIs with parent-child relationship or sibling relationship in the database to obtain the negative example data;
obtaining POIs in which a similarity of character strings in POI names is lower than a threshold value in the database to obtain the negative example data; and
selecting POIs with different core words or suffixes contained in POI names in the database to obtain the negative example data.

10. A point of interest (POI) name matching apparatus, comprising:
a memory;
a processor; and
a computer program;
wherein the computer program is stored in the memory and configured to be executed by the processor to enable the processor to:
obtain a first POI name of a first POI and a second POI name of second first POI that are to be matched; and
obtain a similarity between the first POI name and the second POI name according to a pre-trained network model; and determine that the first POI and the second POI are the same POI entity in name semantics when the similarity is higher than a preset threshold.

11. The apparatus of claim 10, wherein the pre-trained network model comprises a self attention unit and a multi-head attention unit;
the computer program is stored in the memory and configured to be executed by the processor to further enable the processor to:
obtain feature vectors of the first POI name and the second POI name respectively through the self attention unit;
obtain an interaction relation vector between the feature vectors of the first POI name and the second POI name through the multi-head attention unit; and
obtain the similarity between the first POI name and the second POI name according to the interaction relation vector.

12. The apparatus of claim 11, wherein the pre-trained network model comprises two sub-networks which are symmetrical to each other, and each sub-network comprises the self attention unit and the multi-head attention unit;
wherein the first POI name and the second POI name are respectively input into the two sub-networks; the multi-head attention unit of each sub-network is configured to obtain the interaction relation vector of the feature vector of the POI name in the other sub-network with respect to the feature vector of the POI name in that sub-network.

13. The apparatus of claim 12, wherein the pre-trained network model further comprises a splicing unit and a similarity obtaining unit;
the computer program is stored in the memory and configured to be executed by the processor to further enable the processor to:
splice the interaction relation vectors obtained by the two sub-networks through the splicing unit to obtain a spliced interaction relation vector; and
obtain the similarity between the first POI name and the second POI name according to the spliced interaction relation vector through the similarity obtaining unit.

14. The apparatus of claim 11, wherein the pre-trained network model comprises two sub-networks which are symmetrical to each other, each sub-network comprises the self attention unit, the two sub-networks are connected with the multi-head attention unit, and the feature vector of the POI name obtained by the self attention unit of each sub-network is input into the multi-head attention unit to obtain the interaction relation vector between the feature vectors of the first POI name and the second POI name through the multi-head attention unit; the pre-trained network model further comprises a similarity obtaining unit, the computer program is stored in the memory and configured to be executed by the processor to further enable the processor to obtain the similarity between the first POI name and the second POI name according to the interaction relation vector through the similarity obtaining unit.

15. The apparatus of claim 11, wherein the computer program is stored in the memory and configured to be executed by the processor to further enable the processor to:
perform dichotomy according to the interaction relation vector to obtain the similarity between the first POI name and the second POI name.

16. The apparatus of claim 12, wherein the two sub-networks further comprise an embedding layer.

17. The apparatus of claim 16, wherein the computer program is stored in the memory and configured to be executed by the processor to further enable the processor to:
encode the input POI name through the embedding layer to obtain a POI name expressed in vector form, so as to enable the self attention unit to obtain the feature vector of the POI name according to the POI name expressed in vector form.

18. The apparatus of claim 10, wherein the computer program is stored in the memory and configured to be executed by the processor to further enable the processor to:
obtain training data; and
train the pre-trained network model according to the training data.

19. The apparatus of claim 18, wherein the computer program is stored in the memory and configured to be executed by the processor to further enable the processor to perform at least one of the following:
obtaining positive example data in the training data according to POI entities with different names in a database;
constructing negative example data in the training data according to a user's POI query instruction and a corresponding query result;
obtaining POIs with parent-child relationship or sibling relationship in the database to obtain the negative example data;
obtaining POIs in which a similarity of character strings in POI names is lower than a threshold value in the database to obtain the negative example data; and
selecting POIs with different core words or suffixes contained in POI names in the database to obtain the negative example data.

20. A computer readable storage medium, wherein the computer readable storage medium has a computer program stored thereon;
the computer program, when executed by a processor, implements the method of claim 1.
